(19) United States
(12) Patent Application Publication
(10) Pub. No.: US 2024/0140126 A1
(43) Pub. Date: May 2, 2024

(54) A method for numbering, QR coding and/or barcoding of banknotes using laser writing

(71) Applicant: Gleitsmann Security Inks GmbH, Berlin (DE)

(72) Inventor: Roland Gutmann, Falkensee (DE)

(73) Assignee: Gleitsmann Security Inks GmbH, Berlin (DE)

(21) Appl. No.: 18/279,245

(22) PCT Filed: Feb. 17, 2022
(86) PCT No.: PCT/EP2022/054018

§ 371 Date: Aug. 29, 2023

(30) Foreign Application Priority Data
Mar. 1, 2021 (EP) 21160065.5

(51) Int. Cl. B42D 25/41; B41M 3/14; B42D 25/378

(52) U.S. Cl. CPC B42D 25/41; B41M 3/142; B42D 25/378

(57) ABSTRACT

A method for continuously or semi-continuously numbering, QR coding and/or barcoding of banknotes comprises the following steps: i) providing a substrate in form of a sheet of (security) paper or of a sheet of (security) polymer foil or a (security) composite comprising at least one security paper layer and at least one security polymer foil, ii) printing onto each of the two surfaces of the substrate sheet each one or more printing ink layers so as to generate a plurality of banknotes on the substrate sheet, wherein each printing ink layer extends over a part or the whole of the surface area of the substrate sheet, and wherein the printing ink of at least one of the printing ink layers comprises at least one pigment and/or at least one dye, which changes its color upon exposition to laser radiation, iii) curing the printing ink layers, iv) exposing the printed and cured (dried) substrate sheet to laser radiation so as to create one or more features selected from the group consisting of individual numbers each comprising at least two numerals and optionally one or more characters, of individual QR codes, of individual barcodes and arbitrary combinations of two or more of the aforementioned features on each banknote of the printed substrate sheet, wherein all of the one or more individual (serial) numbers, of the one or more QR codes and of the one or more barcodes are generated by the exposure to the laser radiation, and v) cutting the printed substrate sheet obtained in step iv) to individual banknotes.

The present invention relates to a method for numbering and/or barcoding of banknotes and in particular to a method for continuously or semi-continuously numbering, QR coding and/or barcoding of banknotes.

Banknotes must comprise several security features, so that any skilled person is able to reliably determine, whether it is genuine or forged. This is a prerequisite for allowing a recipient of for instance a banknote, such as a cashier at a supermarket, to decide, whether he accepts it or not. In addition, it allows employees of a bank to evaluate the genuineness of banknotes, before filling it into a cash machine or transfer it into the cash desk. Moreover, the existence of such security features avoids or at least significantly hinders unauthorized persons to copy or reengineering the respective article. Furthermore, security features even allow a cash machine or a banknote counting machine to assure that the banknotes are properly aligned during their transport through the machine, which is a prerequisite for reliably counting the number of banknotes. Various sensor systems for detecting fluorescence effects are known, most of which are based on an UV excitation source and a photodiode or image camera that detects and checks the visible emission light, such as described in CA 2 349 681 A1. Examples for security features are security images, which comprise an image being invisible or otherwise undetectable under ambient conditions, but which are rendered visible or detectable upon application of e.g. UV radiation. Alternatively, the image on the banknote may have a first color under ambient conditions, which is changed into a second color being different from the first color upon application of e.g. UV radiation. All these security features are applied onto the surface(s) of the banknotes during the printing process. This printing process is a continuous process, during which a plurality of banknotes is printed simultaneously onto a substrate sheet made of paper or, sometimes, of polymer. Usually up to 10,000 substrate sheets may be printed within one hour, each of these sheets comprising 32 to 80 banknotes, e.g. 54 for 6×9 notes on a single sheet, which are later separated from each other by cutting.

One further very important component of a banknote is the serial number, which is usually applied on one of the two surfaces of the banknote. The serial number consisting of several numerals or digits, respectively, optionally together with one or more characters is not printed together with the printing inks comprising the security features onto the substrate sheets, but afterwards in a separate step. More specifically, the printed substrate sheet is first cured or dried, respectively, and then transferred to a different printing machine, in which the serial numbers are printed onto the sheets with mechanical numbering devices. With cured or dried printed substrate sheet a sheet is meant, in which the printing ink is cured or dried.

Each of these mechanical numbering devices comprises—similar to a date stamp or combination lock—for every numeral and, if present, for every character of the serial number an own cylinder with ten numerals or a plurality of characters so that by respectfully (electronically controlled) rotating the single cylinders the serial number may be adjusted. The so adjusted numerals and optionally characters of the mechanical numbering devices are covered by coating them with printing ink from a drum, whereafter the printing ink is transferred from the mechanical numbering devices onto the sheets. More specifically, the mechanical numbering devices are arranged on a rotating drum, with a plurality of mechanical numbering devices being arranged with regular distance to each other in circumferential direction as well as in the direction perpendicular thereto. The number and arrangement of the mechanical numbering devices on the drum correspond to the number of banknotes printed onto the substrate sheet so that per one rotation of the drum with the mechanical numbering devices, all banknotes printed on one sheet are provided with serial numbers. Thus, if a sheet comprises 50 banknotes, 50 logistically controlled mechanical numbering devices have to be arranged on the drum surface.

However, this process has many drawbacks. First of all, printing inks are penetrating within the open mechanism of the mechanical numbering devices so that the numbering process must be stopped from time to time so as to clean the mechanical parts of the mechanical numbering devices. Such a cleaning step requires several hours, since the single mechanical numbering devices have be taken out of the holders being mounted on the drum, must be dismantled, carefully cleaned, oiled and mounted back into the holders. On account of this, several such numbering systems are required per one banknote printing machine, which outputs continuously up to 10,000 sheets per hour. Therefore, the whole numbering process is time and cost consuming. Moreover, the mechanical numbering devices have to be electrically connected with a control unit so as to allow to electronically adjust the single numbers and optionally characters of the single mechanical numbering devices. This makes the whole numbering apparatus not only very complex, but also accident-sensitive and maintenance-intensive.

In view of this, the object underlying the present invention is to provide a method for continuously or semi-continuously numbering, QR coding and/or barcoding of banknotes, which overcome the aforementioned disadvantages by obviating the need to use mechanical numbering devices.

In accordance with the present invention, this objective is achieved by providing a method for (preferably continuously or semi-continuously) numbering, QR coding and/or barcoding of banknotes comprises the following steps:
i) providing a substrate in form of a sheet of (security) paper or of a sheet of (security) polymer foil or a (security) composite comprising at least one security paper layer and at least one security polymer foil,
ii) printing onto each of the two surfaces of the substrate sheet each one or more printing ink layers so as to generate a plurality of banknotes on the substrate sheet, wherein each printing ink layer extends over a part or the whole of the surface area of the substrate sheet, and wherein the printing ink of at least one of the printing ink layers comprises at least one pigment and/or at least one dye, which changes its color upon exposition to laser radiation,
iii) curing the printing ink layers,
iv) exposing the printed and cured (or dried) substrate sheet to laser radiation so as to create one or more features selected from the group consisting of individual (serial) numbers each comprising at least two numerals and optionally one or more characters, of individual QR codes, of individual barcodes and of arbitrary combinations of two or more of the aforementioned features on each banknote of the printed substrate sheet, wherein all of the one or more individual (serial) numbers, of the one or more individual QR codes and of the one or more individual barcodes are generated by the exposure to the laser radiation, and
v) cutting the printed substrate sheet obtained in step iv) to individual banknotes.

Thus, in contrast to the usual banknote numbering procedure, the method in accordance with the present invention does not make use of open mechanical numbering devices for printing the serial numbers onto the banknote sheets after having printed the other printing ink layers and is therefore not connected with the aforementioned disadvantages. On the contrary, all of the serial numbers, all of the QR codes and all of the barcodes are created in the method in accordance with the present invention by laser writing, i.e. by exposing the printed and cured substrate sheet to laser radiation, wherein the laser beam is moved so that on the printed and cured substrate sheet one or more serial numbers, one or more QR codes and/or one or more barcodes and optionally further individual security features are generated. Advantageously, the laser writing step is much less accident-sensitive as well as much less maintenance-intensive than the use of open mechanical numbering devices. Moreover, a time-consuming cleaning of open mechanical numbering devices is dispensed. Furthermore, the method in accordance with the present invention does not necessarily comprise two completely separate printing steps, wherein first all printing ink layers except the serial numbers, QR codes and barcodes are written onto the substrate sheet, before the so obtained printed sheet is cured (meaning that the printing ink on the sheet is cured, either by exposure to UV radiation in case of an UV curing printing ink or by drying in case of a non-UV curing printing ink) and then in a second printing process step the serial numbers, QR codes and/or barcodes are written onto the printed substrate sheet. On the contrary, all printing ink layers including that or those printing ink layer(s) including the pigment(s)/dye(es) changing its/their color upon exposition to laser radiation for creating the serial number and/or the barcode, which are later activated by the laser exposition step, may be printed simultaneously or one after the other in one continuous or semi-continuous printing process onto the substrate sheet, before the printed substrate sheet is cured and then exposed to laser radiation so as to create—by laser writing—one or more individual (serial) numbers each comprising at least two numerals and optionally also one or more characters, such as typically 10 to 14 numerals and characters in total, one or more QR codes and/or to create one or more barcodes on each banknote of the printed substrate sheet. Consequently, the speed for laser writing the serial numbers, OR codes and/or barcodes onto the substrate sheets has to be exactly the speed of printing the other printing layers onto the substrate sheets. In addition, the pigment(s) and/or dye(s) changing its/their color upon exposition to laser radiation may be incorporated into one of the printing ink(s) required for applying one or more other security features onto the substrate sheet, so that in fact one printing step may be saved. Semi-continuous means in accordance with the present invention that at least a part of the process is performed continuously. Another advantage of the method in accordance with the present invention is that it allows to perform the laser writing with laser radiation having a comparably low wavelength of 200 to 800 nm, which allows to generate serial numbers, QR codes and barcodes with a high resolution, which are thus reliably machine detectable and readable with standard software. Thereby, even very small QR codes and barcodes of e.g. 5×5 mm or even smaller may be generated in high resolution.

In accordance with the present invention, the term printing ink means any printable composition comprising a dye and/or pigment, so that even in the case that the dye and/or pigment is transparent or colorless, the composition is considered as printing ink and not as printing varnish. The same applies if the included pigment or dye is only detectable in the ultraviolet or infrared region.

Number means in accordance with the present invention any number consisting solely of numerals as well as alphanumeric numbers comprising one or more numerals and one or more characters. Thus, creating one or more individual (serial) numbers means comprising at least two numerals and optionally one or more characters on each banknote of the printed substrate sheet means in accordance with the present invention any (alphanumeric) number comprising two or more numerals (i.e. two or more numerals form 0 to 9) and optionally one or more characters (i.e. A, B, C or any other), such as typically in sum of numerals and characters 8 to 12.

In accordance with the present invention, all of the one or more individual (serial) numbers, one or more QR codes and one or more barcodes are generated by the exposure to the laser radiation. This means that the method does not comprise any mechanical (typography) numbering or barcoding, i.e. the process is performed without any mechanical numbering device, without any mechanical QR coding device and without any mechanical barcoding device, and that the all of the one or more individual (serial) numbers, one or more QR codes and one or more barcodes are generated by the exposure to the laser radiation are not generated by any other technique than laser writing, such as in particular not generated by an inkjet process, an embossing process or the like. Usually, banknotes comprise one serial number on one of the two banknote sides. In addition, the banknote may comprise a second serial number on the other side of the banknote, one or more QR codes and/or one or more barcodes on one or both sides of the banknote. Still alternatively, the banknote may comprise no serial number, but one or more QR codes and/or one or more barcodes on one or both sides of the banknote. In any of these cases, in accordance with the present invention all serial numbers, if any, all QR codes, if any, and all barcodes, if any, are generated on the banknote by means of the laser writing step.

Furthermore, a pigment or dye changing its color upon exposition to laser radiation is in accordance with the present invention a pigment or dye changing its color upon exposition to laser radiation without participation of any further compound or reactant, respectively, due to the molecule specific energy of the pigment or dye, for instance by a changing its optical properties as direct consequence of the irradiation with laser radiation. Alternatively, the pigment or dye changing its color upon exposition to laser radiation may change its color upon exposition to laser radiation with participation of one or more further compounds or reactants, respectively. For instance, a further compound included in the printing ink may work as activator, when exposed to laser radiation, so that the pigment or dye may react upon exposure to the laser radiation with another reactant, thereby forming reaction products having another color than the educt(s). It is preferred that the the pigment or dye is not decomposed upon the exposition to laser radiation, i.e. that the color change upon the exposition to laser radiation is not the result of a decomposition reaction of the pigment or dye.

In accordance with a particular preferred embodiment of the present invention, all printing ink layers including that or those printing ink layer(s) including the pigment(s)/dye(es) changing its/their color upon exposition to laser radiation for creating the serial number, for creating the QR code and/or for creating the barcode, which are later activated by the laser exposition step iv), are printed simultaneously or one after the other in one continuous printing process onto each of the two surfaces of the substrate sheet, before the printed substrate sheet is cured and exposed to laser radiation. In this embodiment, all printing ink layers are simultaneously cured in step iii). Moreover, it is preferred that all printing ink layers including that or those printing ink layer(s) including the pigment(s)/dye(es) changing its/their color upon exposition to laser radiation for creating the serial number, QR code and/or barcode, which are later activated by the laser exposition step iv), are printed onto each of the two surfaces of the substrate sheet on one print roller, i.e. that the method uses only one print roller. This one-step method is not only time saving, but also particularly economical.

However, even if generally less preferred, it is possible to first print only those printing ink layers not including the pigment(s)/dye(es) changing its/their color upon exposition to laser radiation. Afterwards, the substrate sheet being printed with these printing ink layers may be cured, before one or more printing ink layers comprising at least one pigment and/or at least one dye, which changes its color upon exposition to laser radiation, is/are printed onto the uppermost printing ink layer of the sheet having been cured before. Afterwards, the printed sheet is cured again, before the laser writing step iv) is performed. In this embodiment, step iii) is performed in two sub-steps. This embodiment may be advantageous, if one or more UV-curing printing ink layers are used in combination with one or more non-UV curing printing ink layers. In this case, the non-UV curing printing ink layers are separately applied to the substrate and dried, either before or after the UV curing printing ink layers are applied to the substrate and cured upon exposure to UV radiation.

Moreover, it is preferred that in step iv) the laser radiation is radiated onto the one side of the printed and cured substrate sheet, onto which printing ink comprising at least one pigment and/or at least one dye, which changes its color upon exposition to laser radiation, is printed, if only one side of the printed and cured substrate sheet comprises ink comprising at least one pigment and/or at least one dye, which changes its color upon exposition to laser radiation. However, if both sides of the printed and cured substrate sheet comprise ink comprising at least one pigment and/or at least one dye, which changes its color upon exposition to laser radiation, it is preferred that the laser radiation is radiated onto both sides of the printed and cured substrate sheet by using two lasers. Thereby, the laser radiation may be applied with the lowest possible energy intensity, because the laser radiation is applied directly onto the printing ink comprising at least one pigment and/or at least one dye, which changes its color upon exposition to laser radiation, and does not first have to pass through the substrate sheet, before reaching the printing ink comprising at least one pigment and/or at least one dye, which changes its color upon exposition to laser radiation. Such a pass of laser radiation through the substrate sheet would be necessary, if the laser radiation would be applied onto the side of the substrate sheet being opposite to that onto which the printing ink comprising at least one pigment and/or at least one dye, which changes its color upon exposition to laser radiation, is applied. If the laser is applied onto the side of the substrate sheet being opposite to that onto which the printing ink comprising at least one pigment and/or at least one dye, which changes its color upon exposition to laser radiation, is applied, higher laser energy intensities have to be applied, which may decompose the pigments and/or dyes of the printing ink(s) and/or may decompose the substrate sheet.

In accordance with another particularly preferred embodiment of the present invention, the printed and cured substrate sheet is exposed in step iv) to laser radiation having a wavelength of 200 to 1,100 nm, preferably of 200 to less than 800 nm and more preferably of 350 to 790 nm, such as of 355 nm, of 405 nm, of 485 nm or of 785 nm. This allows to generate serial numbers, QR codes and/or barcodes with a high resolution, which are thus reliably machine detectable and readable with standard software. Thereby, even very small QR codes and barcodes of 5×5 mm or even smaller may be generated in high resolution.

In principle, the method in accordance with the present invention is flexible concerning the location of the at least one of the printing ink layers comprising at least one pigment and/or at least one dye, which changes its color upon exposition to laser radiation. Accordingly, the at least one of the printing ink layers comprising at least one pigment and/or at least one dye, which changes its color upon exposition to laser radiation, may be the lowermost printing ink layer placed directly on a surface of the substrate sheet, may be the uppermost printing ink layer of the banknote or may be any printing ink layer between the lowermost and uppermost printing ink layer. Moreover, the at least one of the printing ink layers comprising at least one pigment and/or at least one dye, which changes its color upon exposition to laser radiation, may or may not contain any further pigments and/or dyes not changing their color upon exposition to laser radiation. It is preferred that at least one of the printing ink layers comprising the at least one pigment and/or at least one dye changing its color upon exposition to laser radiation is the uppermost printing ink layer on one of the two surfaces or on both of the surfaces of the substrate sheet.

As set out above, one, two or more printing ink layers comprising the at least one pigment and/or at least one dye changing its color upon exposition to laser radiation may be printed onto the substrate. Preferably, only one of the printing ink layers—and preferably one of the two uppermost printing ink layers on both surfaces of the substrate sheet—comprises the at least one pigment and/or at least one dye changing its color upon exposition to laser radiation and the others not.

In a further development of the idea of the present patent application it is suggested that the printing ink of the at least one of the printing ink layers comprising at least one pigment and/or at least one dye changing its color upon exposition to laser radiation is transparent or colorless. This embodiment is particularly preferred if the at least one of the printing ink layers comprising at least one pigment and/or at least one dye changing its color upon exposition to laser radiation is the uppermost printing ink layer on one surface of the sheet substrate. In the case of being transparent, the respective printing ink layer does not at all hide color and optional security features of the one or more lower printing ink layers and in the later laser writing step iv), the serial number, QR code and/or barcode and optionally also other graphical features, such as any other individual graphic, is generated in this transparent field and thus with high resolution. In the case of being colorless, but not transparent, the respective printing ink layer does hide color and optional security features of the one or more lower printing ink layers, but also generates in the later laser writing step iv) a clearly visible and highly resolved serial number, QR code and/or barcode and optionally also other graphical features, such as any individual graphic.

In accordance with a further preferred embodiment of the present invention, the printing ink of at least one of the printing ink layers comprises two or more of pigment(s) and/or dye(s), wherein each of the two or more of pigment(s) and/or dye(s) forms a different color upon exposition to laser radiation with a given intensity and wavelength and/or signal shape (continuous or pulsed laser beam). This allows to generate during the laser writing step iv) serial numbers, QR codes, barcodes and other individual security features with different colors. For instance, the first two characters of the serial number may have a different color than the numerals of the serial number or the second and fourth numeral of the serial number may have a different color than the numerals and optional characters of the serial number.

Alternatively to the aforementioned embodiment or in addition to the aforementioned embodiment, the color of the at least one pigment and/or at least one dye changing its color upon exposition to laser radiation contained in the printing ink of at least one of the printing ink layers, which the at least one pigment and/or at least one dye has after termination of the exposition to laser radiation, depends on the wavelength and/or the intensity of the laser so that the at least one pigment and/or at least one dye may change its color upon exposition to laser radiation to one of a plurality of colors. This allows to generate in the later laser writing step iv) serial numbers, QR codes, barcodes and optional further individual security features having two different colors, even if only one pigment or dye changing its color upon exposition to laser radiation is included in the respective printing ink layer.

In the aforementioned embodiment, it is preferred that the printed and cured substrate sheet is exposed in step iv) to at least two different laser radiation wavelengths and/or to at least two different laser radiation intensities so as to create one or more individual serial numbers, each comprising at least two numerals and optionally one or more characters, wherein the numerals and optionally one or more characters of at least one serial number have different colors, and/or to create one or more QR codes and/or one or more barcodes and optionally one or more further individual security element(s), wherein a part of the QR code and/or barcode and optionally one or more further individual security element(s) has a different color than another part thereof.

The at least one pigment and/or at least one dye changing its color upon exposition to laser radiation may be any pigment or dye which changes its color upon exposition to laser radiation, independent from the underlying mechanism. For instance, even if least preferred, the pigment or dye may decompose upon exposition to laser radiation and thereby changes its color, for instance from transparent or colorless, to blue or black. For example, the pigment or dye may carbonize during the exposure to laser radiation, thus forming a black color at those locations penetrated the printing ink. However, it is more preferred that the pigment or dye changes its color without decomposition.

Preferably, the pigment or dye changing its color upon exposition to laser radiation may be part of a reactive system, which forms upon exposition to laser radiation a color change. In this embodiment, it is preferred that at least one of the printing ink layers comprising the at least one pigment and/or at least one dye changing its color upon exposition to laser radiation further comprises at least one sensitizer.

The at least one sensitizer is preferably a light-to-heat convertor, which generates heat upon exposure to laser light. In this embodiment, the heat generated by the sensitizer may activate a decomposition of the pigment or dye, thus leading to a color change of the pigment or dye. Alternatively, heat generated by the sensitizer may activate a reaction between the pigment or dye with another reactant leading to reaction products having another color than the pigment or dye. The aforementioned reaction may be activated by the heat generated by the sensitizer upon exposition to laser radiation by selecting the dye/pigment and reactant so that a color changing chemical reaction is initiated at ambient temperature, but initiated by the heat provided by the sensitizer upon exposure to laser radiation by providing the necessary activation energy. Alternatively, the aforementioned reaction may be activated by the heat generated by the sensitizer upon exposition to laser radiation by placing the pigment or dye in capsules made of a polymer shell so that the printing ink layer comprises the capsules including the pigment or dye and outside the capsules the reactant, wherein the heat generated by the sensitizer upon exposition to laser radiation destroys the polymer shell of the capsule, thus allowing that the pigment or dye comes into contact with the reactant so that the color changing chemical reaction takes place.

Good results are in particular obtained, when the at least one sensitizer is an infrared absorbing dye. The at least one infrared absorbing dye is preferably selected from the group consisting of polymethyl indoliums, metal complex infrared dyes, indocyanine green, polymethine dyes, croconium dyes, cyanine dyes, merocyanine dyes, squarylium dyes, chalcogeno-pyryloarylidene dyes, metal thiolate complex dyes, quinoline dyes, indolenine dyes, bis(chalcogenopyrylo)-polymethine dyes, oxyindolizine dyes, bis(aminoaryl)polymethine dyes, indolizine dyes, pyrylium dyes, quinoid dyes, quinone dyes, phthalocyanine dyes, naphthalo-cyanine dyes, azo dyes, (metalized) azomethine dyes and arbitrary combinations of two or more of the aforementioned compounds. Preferred examples for suitable sensitizers of the infrared absorbing dye-type are polymethine dyes and benzo[cd]indoline dyes, such as 5-[2,5-bis[2-[1-(1-methylbutyl)-benz[cd]indol-2(1 H)-ylidene]ethylidene]-cyclopentylidene]-1-butyl-3-(2-methoxy-1-methylethyl)-2,4,6(1 H,3H,5H)-pyrimidinetrione.

Good results are also obtained, when the at least one sensitizer is an infrared absorbing pigment. The at least one infrared absorbing pigment is preferably a carbon black, a cyanine pigment, a merocyanine pigment or a compound being selected from the group consisting of oxides, hydroxides, sulfides, sulfates and phosphates of metals such as copper, bismuth, iron, nickel, tin, zinc, manganese, zirconium, tungsten, lanthanum and antimony. More preferably, the infrared absorbing pigment is carbon black, such as acetylene black, channel black, furnace black, lamp black or thermal black. The d₅₀-particle diameter of the infrared absorbing pigment is preferably 0.02 to 5 μm, whereas the concentration of the infrared absorbing pigment is preferably 0.001 to 0.1% by weight based on the total weight of the (wet) printing ink of the respective printing layer.

As indicated above, it is preferable that the at least one pigment and/or at least one dye changing its color upon exposition to laser radiation is encapsulated in a capsule made of a polymeric shell. This allows to immobilize the homogenously distributed capsules in the cured printing ink layer so that in the laser writing step iv) an accurate and precise serial number, QR code and/or barcode as well as optionally further individual security features may be generated. Moreover, this allows to separate the pigment and/or dye changing its color upon exposition to laser radiation from an optional reactant, by placing the reactant within the printing ink outside the capsules. The at least one sensitizer may be contained in the capsules or outside thereof. However, it is preferred that the at least one sensitizer is contained in the capsules, so as to be close to the polymer shell.

Good results are in particular obtained in this embodiment, when the polymeric shell of the capsule is made of a polymer being selected from the group consisting of polyamides, polyurea, polyurethanes, polysulfonamides, polyesters, polycarbonates and arbitrary combinations of two or more of the aforementioned polymers. The average diameter of the capsules are preferably less than 5 μm, such as 0.1 to 5 μm infrared absorbing pigment is preferably 0.05 to 5 μm, whereas the concentration of the infrared absorbing pigment is preferably 0.01 to 10% by weight, more preferably 0.01 to 5% by weight, even more preferably 0.1 to 3% by weight and most preferably 0.1 to 2% by weight based on the total weight of the (wet) printing ink.

As set out above, the color change during the laser writing step iv) may be achieved by a reaction of the pigment and/or dye initiated upon exposure to the laser radiation with another reactant, thereby forming reaction products having another color than the educts. It is preferred in this embodiment that at least one of the printing ink layers comprising the at least one pigment and/or at least one dye changing its color upon exposition to laser radiation further comprises at least one developer compound and/or at least one thermal acid generating compound, wherein the developer compound and/or thermal acid generating compound chemically reacts with the pigment and/or dye so as to cause a color change of respective cured printing ink layer. This embodiment may in addition use in the printing ink of the respective printing ink layer—in addition to the color changing pigment and/or dye and in addition to the at least one developer compound and/or at least one thermal acid generating compound—one or more sensitizers as described in detail above. The one or more sensitizers convert upon exposure with laser radiation the laser radiation into heat, which activates the chemical reaction between i) the color changing pigment and/or dye and ii) the developer compound and/or thermal acid generating compound. Alternatively, the one or more sensitizers convert upon exposure with laser radiation the laser radiation into heat, which decomposes the polymeric shell of capsules being homogeneously distributed within the printing ink, wherein the color changing pigment and/or dye and preferably also the one or more sensitizers are located within the capsules, wherein the developer compound and/or thermal acid generating compound is located in the printing ink outside the capsules. After decomposition of the polymeric shells of capsules, the pigment and/or dye chemically react with the developer compound and/or thermal acid generating compound, thereby generating the color change of the printing ink.

Preferably, the least one developer compound is a phenolic compound, an organic acidic compound, an inorganic acidic compound or an ester or salt thereof. These developer compounds are in particularly suitable to be used, when the color changing pigment(s) or dye(s) and optionally at least one sensitizer is/are located in capsules made of polymer shells. However, it may also be used in embodiments not making use of capsules. Specific examples for suitable developer compounds are bisphenol compounds, gallic acid, salicylic acid, salicylate compounds, monophenol compounds, catechol, catechol compounds, resorcin, hydroquinone, pyrogallol, fluoroglycine, fluoroglycine carboxylates, sulfone compounds, tartaric acid, oxalic acid, maleic acid, citric acid, succinic acid, stearic acid, 4-hydroxyphthalic acid, boric acid, thiourea compounds and arbitrary combinations of two or more of the aforementioned compounds. The concentration of the developer compound based on the total weight of the (wet) printing ink layer is preferably 0.1 to 10% by weight and more preferably 0.5 to 2% by weight.

Preferably, the least one thermal acid generating compound are a sulfonate esters, phosphonate esters, iodonium salts, sulfonium salts, ferrocenium salts, sulfonyl oximes, halomethyl triazines, halomethyl-arylsulfones, haloacetophenones, sulfonate esters, t-butyl esters, allyl substituted phenols, t-butyl carbonates and phosphate esters. These thermal acid generating compounds are in particularly suitable to be used, when the color changing pigment(s) or dye(s) and optionally at least one sensitizer is/are located in capsules made of polymer shells. However, it may also be used in embodiments not making use of capsules. The concentration of the thermal acid generating compound based on the total weight of the (wet) printing ink layer is preferably 0.1 to 5% by weight and more preferably 0.5 to 2% by weight.

In a further development of the idea of the present patent application it is proposed that the at least one pigment and/or at least one dye changing its color upon exposition to laser radiation is selected from the group consisting of spirobenzopyrans, spironaphtooxazines, spirothiopyrans, quinone dyes, oxazines, diazines, thiazines, phenazine, triarylmethane phtalides, diarylmethane phthalides, monoarylmethane phthalides, heterocyclic substituted phthalides, alkenyl substituted phthalides, bridged phthalides, bisphthalides, fluoresceins, rhodamines, rhodols, crystal violet, ketazines and arbitrary combinations of two or more of the aforementioned compounds. These pigments and dyes are in particularly suitable to be used, when the color changing pigment(s) or dye(s) and optionally at least one sensitizer is/are located in capsules made of polymer shells. However, they may also be used in embodiments not making use of capsules.

Suitable examples for dyes changing their color upon exposure to laser radiation without needing to be encapsulated into capsules and not requiring a developer or thermal acid generating compound, are mixed carbonate esters of a quinophthalone and a tertiary alkanol containing not more than about 9 carbon atoms and thermally instable carbamate compounds. These compounds undergo a fragment reaction or an irreversible unimolecular fragmentation, respectively, upon heat, such as generated by laser radiation with or without use of a sensitizer compound. Suitable thermal acid generating compounds for these dyes are those mentioned above.

As set out above, the printing ink layer changing its color upon exposure to laser radiation may contain at least two different dyes/pigments forming different colors upon exposure to laser radiation. In this embodiment, the respective printing ink may contain, depending from the nature of the dyes/pigments, at least two different sensitizers as mentioned above and/or at least two different developer compounds as mentioned above and/or at least two different thermal acid generating compound as mentioned above. Again, the dyes/pigments and optionally the sensitizers may be included in capsules made of a polymeric shell, which are homogeneously distributed within the printing ink layer.

Preferably, the printing ink of the at least one of the printing ink layers comprising at least one pigment and/or at least one dye changing its color upon exposition to laser radiation has a total concentration of pigments and dyes changing its color upon exposition to laser radiation of 0.01 to 10% by weight, preferably 0.5 to 5% by weight and more preferably 1 to 3%.

The thickness of the at least one of the printing ink layers comprising at least one pigment and/or at least one dye changing its color upon exposition to laser radiation is preferably 0.5 to 25 μm and more preferably 1 to 10 μm.

The thickness of any optional further printing ink layer not containing at least one pigment and/or at least one dye changing its color upon exposition to laser radiation, is preferably 1 to 20 μm and more preferably 2 to 15 μm.

The present invention is not particularly limited concerning the printing technique, with which the (security) printing ink layers are applied onto the substrate sheet. In particular, the (security) printing ink(s) may be formulated as printing ink being selected from the group consisting of offset inks, intaglio inks, die embossing inks, flexographic inks and screen inks.

In addition to the pigment(s) and/or dye(s), the printing ink(s) used for the at least one printing ink layer in accordance with the present invention include one or more binders, wherein the binder(s) is/are preferably selected from the group consisting of polyesters, polyethers, polyurethanes, polyamides, polyacrylates, maleinate resins, collophonium resins, ketone resins, alkyd resins, collophonium modified phenolic resins, hydrocarbon resins, silicates, silicones, silanes, phenolic resins, urea resins, melamine resins, polyterpene resins, polyvinylalcohols, polyvinylacetates, polyvinylchloride, polyvinylethers, polyvinylpropionates, polymethacrylates, polystyrenes, polyolefines, coumarone-indene resins, aromatic formaldehyde resins, carbamide acid resins, sulfonamide resins, chlorinated resins, nitrocellulose, CAB (cellulose acetate butyrate), CAP (cellulose acetate propionate), cellulose compounds, rubbers, radiation curing resins and arbitrary combinations of two or more of the aforementioned binders.

Moreover, it is preferred that at least one of and preferably all of the printing inks of the printing ink layers contain at least one solvent, which is preferably one or more vegetable oils.

In accordance with a further preferred embodiment of the present invention, at least one of and preferably each of the printing inks of the printing ink layers comprises:
i) 0.01 to 50% by weight and preferably 0.5 to 30% by weight in sum all pigments and dyes,
ii) 10 to 40% by weight and preferably 20 to 30% by weight of one or more binders,
iii) 20 to 60% by weight and preferably 30 to 40% by weight of one or more solvents and
iv) optionally 0.1 to 10% by weight of one or more additives being selected from the selected from the group consisting of rheological additives, adhesives, defoamers, slip additives, anti-corrosion additives, gloss additives, waxes, wetting agents, curing agents, chelating agents, photoinitiators, inhibitors, desiccants, stabilizers, emulsifiers, pH adjustment additives, abrasion resistance additives, plasticizers, antistatic additives, preservatives, light protection agents, matting agents and arbitrary combinations of two or more of the aforementioned additives.

A suitable offset ink may comprise:
Sum of pigments and dyes: 0.01 to 50% by weight
Filler: 0-5% by weight
Alkyd resin: 15-20% by weight
Vegetable oil: 5-15% by weight
Phenolic modified rosin resin: 10-20% by weight
Wax: 0.5-5% by weight
Hydrochinon stabilizer: 0-1.5% by weight
Oxidatively drying agent: 1-2% by weight

Suitable colored pigments not changing their color upon exposure to laser radiation are available from BASF SE, from Clariant Plastics & Coatings Ltd., from Heubach GmbH and from Ferro Performance Pigments, S. L., Pigments in the form of titanium dioxide can be purchased from The Chemours Company TT, LLC, from The Kerala Minerals & Metals Ltd. and from Shandong Doguide Group Co., Ltd.

Suitable fillers are available e.g. from Evonik Industries AG, Krahn Chemie GmbH, BCD Chemie GmbH, Omya AG, Bassermann minerals GmbH & Co. KG, BYK-Chemie GmbH, Elementis plc and Solvay GmbH.

Alkyd resins can be purchased e.g. from Lawter, Inc., Allnex Resins Germany GmbH, Synthopol Chemie Germany and Dr. rer. pol. Koch GmbH & Co. KG.

Suitable vegetable oils are e.g. calendula, canola, castor, china wood, coconut, cottonseed, dehydrated castor, flaxseed, grape seed, linseed, palm, palm kernel, peanut, rapeseed, diticica, safflower, soyabean, sunflower, tall and tung supplied e.g. by Alberdingk Boley GmbH and Mercur Handel GmbH.

Eligible phenolic modified rosin resins are available e.g. from Lawter, Inc., Respol Resinas, S. A. and Euro-Yser—Produtos Quirnicos, S. A.

Waxes and stabilizers may also be contained in the offset inks. Suitable and suppliers for waxes are e.g. euroceras Sp. z o.o. and Eastman Chemical Company and Clariant Plastics & Coatings Ltd. Stabilizers are obtained from Eastman Chemical Company, Ratnagiri Chemicals Pvt. Ltd. and Merck KGaA.

Oxidatively drying agent like metal carboxylates or metal soaps of e.g. cobalt, manganese, iron, vanadium, lead, zirconium, lithium or strontium, cerium, aluminium, potassium, calcium, barium or zink are available e.g. from OMG Borchers GmbH.

A suitable UV-curing water-based screen ink may comprise:
Sum of pigments and dyes except
pearlecent pigments: 0.1 to 25% by weight
Pearlescent pigment: 6-15% by weight
Urethane acrylate dispersion: 60-80% by weight
Wetting additive: 0.1-2.5% by weight
Substrate wetting additive: 0.1-2.5% by weight
Defoamer: 0.1-2.5% by weight
Photoinitiator: 2-10% by weight

Suitable urethane acrylate dispersions are available e.g. from Sartomer Europe—Arkema, Allnex Resins Germany GmbH or Alberdingk Boley GmbH.

Suitable wetting agents are available e.g. from Evonik Industries AG, BYK-Chemie GmbH, Munzing Chemie GmbH and Elementis plc.

Suitable defoamers for water-based formulations are available e.g. from Evonik Industries AG, BYK-Chemie GmbH, Munzing Chemie GmbH and Elementis plc.

Suitable photoinitiators for radically curing systems are supplied e.g. by IGM Resins B.V. or Lambson Ltd.

A suitable cationically radiation-curing screen ink may comprise:
Sum of pigments and dyes: 0.01 to 30% by weight
Pearlescent pigment: 0-25% by weight
Cycloaliphatic epoxide resin: 60-80% by weight
Fumed silica: 0.5-10% by weight
Defoamer: 0.1-5% by weight
Photosensitizer: 0.1-2% by weight
Photoinitiator: 2-10% by weight

Cycloaliphatic epoxide resins are available e.g. form Dow Chemical Company, Gabriel Chemical or IGM Resins B.V.

Fumed silica is supplied e.g. by Evonik Industries AG and Orisil Ltd.

Defoamers are available e.g. from Evonik Industries AG and BYK-Chemie GmbH.

Photosensitizers are supplied e.g. by Lambson Ltd, IGM Resins B.V., Merk KGaA and TCI Deutschland GmbH.

Suitable photoinitiators are available e.g. from Dow Chemical Company, Lambson Ltd, IGM Resins B.V. and BASF SE.

A suitable intaglio ink may comprise:
Sum of pigments and dyes: 0.5 to 55% by weight
Filler 20-60% by weight
Alkyd resin 5-30% by weight
Vegetable oil 5-25% by weight
Phenolic modified rosin resin 5-10% by weight
Wax 3-15% by weight
Drier 0.1-2.5% by weight
Diluent 1-10% by weight

Suitable colored pigments not changing their color upon exposure to laser radiation are available e.g. from BASF SE, Clariant Plastics & Coatings Ltd, Heubach GmbH and Ferro Performance Pigments, S.L. Pigments in the form of titanium dioxide are available e.g. from The Chemours Company TT, LLC, The Kerala Minerals & Metals Ltd. and Shandong Doguide Group Co., Ltd.

Suitable fillers are available e.g. from Evonik Industries AG, Krahn Chemie GmbH, BCD Chemie GmbH, Omya AG, Bassermann minerals GmbH & Co. KG, BYK-Chemie GmbH, Elementis plc and Solvay GmbH.

Alkyd resins can be purchased e.g. from Lawter, Inc., Allnex Resins Germany GmbH and Synthopol Chemie—Dr. rer. pol. Koch GmbH & Co. KG.

Suitable vegetable oils are e.g. calendula, canola, castor, china wood, coconut, cottonseed, dehydrated castor, flaxseed, grape seed, linseed, palm, palm kernel, peanut, rapeseed, oIticica, safflower, soyabean, sunflower, tall and Lung supplied e.g. by Alberdingk Boley GmbH and Mercur Handel GmbH.

Eligible phenolic modified rosin resins are available e.g. from Lawter, Inc., Respol Resinas, S.A., Arizona Chemical Ltd. and Euro-Yser—Produtos Quirnicos, S.A.

Waxes and stabilizers may also be contained in the intaglio inks. Suitable suppliers for waxes are e.g. from euroceras Sp. z o.o. and Clariant Plastics & Coatings Ltd and BYK-Chemie GmbH.

Oxidative driers like metal carboxylates or metal soaps of e.g. cobalt, manganese, iron, vanadium, lead, zirconium, lithium or strontium, cerium, aluminium, potassium, calcium, barium or zink are available e.g. from OMG Borchers GmbH.

Suitable diluents or thinners are available e.g. from Shell Global Solutions International B.V., Total S.A. and Alberdingk Boley GmbH.

An effect pigment can also be incorporated.

The other components are preferably those mentioned above for the offset security ink composition.

The present invention is not particularly restricted concerning the kind of substrate, as long as it is a (security) paper sheet, a (security) polymer foil or a (security) composite comprising at least one paper layer sheet and at least one polymer foil. The polymer of the polymer foils may be in particular selected from the group consisting of polycarbonate foils, polyethylene terephthalate foils, composites of a lower security paper and an upper polymer foil, composites of a lower polymer foil and an upper security paper, composites of a lower security paper, an intermediate polymer foil and an upper security paper, composites of a lower polymer foil, an intermediate security paper and an upper polymer foil and hybrids of a security paper, in which a part of the security paper is replaced by a polymer foil.

The curing of the printing ink layers is preferably performed in case of non-UV curing printing inks by drying at a temperature between 23 and 130° C. and preferably between 23 and 60° C., preferably in a heating room, in an oven or in any other heated space. In case of UV curing printing inks, the curing is performed by exposing the printing ink layers to UV radiation, for instance to UV radiation having an energy intensity of 200 to 400 J/cm 2.

Principally, the present invention is not particularly limited concerning the kind, how the one or more individual numbers each comprising at least two numerals, one or more QR codes and/or one or more barcodes on each banknote of the printed substrate sheet are generated in step iv) by laser writing, i.e. by exposing the printed and cured substrate sheet to laser radiation. Preferably, in step iv) one or more laser beams are moved relatively to the moving or non-moving substrate sheet so that on the printed and cured substrate sheet one or more serial numbers, one or more QR codes and/or one or more barcodes and optionally further individual security features are generated. The number of laser beams required, depend on the width of the printed and cured substrate sheet and may be between 1 and 10 laser beams and preferably between 1 and 6 laser beams. The movement of the one or more laser beams relative to the substrate sheet may be effected by only moving the laser beam(s) or by moving the laser beam(s) as well as moving the substrate sheet, for instance by rotating the substrate sheet on a cylindrical drum or in the transport area of the sheets after the curing. The movement of the one or more laser beams may be achieved by an appropriate arrangement of movable mirrors and/or movable lenses, which are controlled by a computer software. Moreover, a commercially available three-dimensional multi-sensor positioning system may be used, such as NMM-1 distributed by Sios Messtechnik GmbH, Ilmenau, Germany. If more than one laser beam is used, the laser beams may have different wavelengths. For instance, a YAG laser may be used having a base wavelength of 1,064 nm which leads by frequency doubling to 532 nm and/or even by triplication to 266 nm.

Any appropriate laser may be used, such as a femtosecond laser, such as a titanium:saphir-femtosecond laser, as it is distributed by Integral Pro, FEMTOLASERS Produktions GmbH, Wien, Austria. Preferably, in step iv) one or more pulsed laser beams are used, each of which preferably having a pulse duration of 1 fs to 1 ns and preferably of 100 fs to 1 ps. This results in a precise and highly spaceresolved serial number, OR code, barcode or other individual security feature.

In a further development of the idea of the present invention it is proposed that in step iv) one or more pulsed laser beams are used, each of which having a wavelength of 200 nm to 2,000 nm and preferably of 250 to 1,100 nm. As set out further above, it is particularly preferred that the printed and cured substrate sheet is exposed in step iv) to laser radiation having a wavelength of 200 to 1,100 nm, preferably of 200 to less than 800 nm and more preferably of 350 to 790 nm, such as of 355 nm, of 405 nm, of 485 nm or of 785 nm. This allows to generate serial numbers, QR codes and/or barcodes with a high resolution, which are thus reliably machine detectable and readable with standard software. Thereby, even very small QR codes and barcodes of 5×5 mm or even smaller may be generated in high resolution. Preferably, the wavelength can be varied so that two or more laser-sensitive pigments or dyes or sensitizers may be activated, if a serial number with numerals and optionally characters, one or more QR codes and/or one or more barcodes or optional one or more other individual security features having two or even more different colors shall be generated.

In accordance with a further preferred embodiment of the present invention, in step iv) one or more pulsed laser beams are used, each of which having energies of 10 mW to 1 kW and preferably of 100 mW to 100 W. Preferably, the energy intensity can be varied so that two or more laser-sensitive pigments or dyes or sensitizers may be activated, if a serial number with numerals, one or more QR codes and/or one or more barcodes and optionally characters or optional one or more other individual security features having two or even more different colors shall be generated.

Preferably, in step iv) on every banknote printed on the substrate sheet each one or more serial numbers and optionally one or more QR codes and/or one or more barcodes and optionally further individual security features are generated.

A further aspect of the present invention is a banknote obtainable with the aforementioned method.

1. A method for numbering, QR coding and/or barcoding of banknotes, wherein the method comprises the following steps:
i) providing a substrate sheet in form of a sheet of paper or of a polymer foil or a composite comprising at least one security paper layer and at least one security polymer foil,
ii) printing onto each of the two surfaces of the substrate sheet each one or more printing ink layers so as to generate a plurality of banknotes on the substrate sheet, wherein each printing ink layer extends over a part or the whole of the surface area of the substrate sheet, and wherein the printing ink of at least one of the printing ink layers comprises at least one pigment and/or at least one dye, which changes its color upon exposition to laser radiation,
iii) curing the printing ink layers,
iv) exposing the printed and cured substrate sheet to laser radiation so as to create one or more features selected from the group consisting of individual numbers each comprising at least two numerals, of QR codes, of barcodes and arbitrary combinations of two or more of the aforementioned features on each banknote of the printed substrate sheet, wherein all of the one or more individual (serial) numbers, of the one or more QR codes and of the one or more barcodes are generated by the exposure to the laser radiation, and
v) cutting the printed substrate sheet obtained in step iv) to individual banknotes.

2. The method in accordance with claim 1, wherein in step ii) all printing ink layers including that or those printing ink layer(s) including the pigment(s)/dye(es) changing its/their color upon exposition to laser radiation are printed simultaneously or one after the other in one continuous printing process onto each of the two surfaces of the substrate sheet, preferably using only one print roller.

3. The method in accordance with claim 1, wherein in step iv) the laser radiation is radiated onto the one side of the printed and cured substrate sheet, onto which printing ink comprising at least one pigment and/or at least one dye, which changes its color upon exposition to laser radiation, is printed, if only one side of the printed and cured substrate sheet comprises ink comprising at least one pigment and/or at least one dye, which changes its color upon exposition to laser radiation, or the laser radiation is radiated onto both sides of the printed and cured substrate sheet, if both sides of the printed and cured substrate sheet comprise ink comprising at least one pigment and/or at least one dye, which changes its color upon exposition to laser radiation.

4. The method in accordance with claim 1, wherein the printed and cured substrate sheet is exposed in step iv) to laser radiation having a wavelength of 200 to 800 nm, preferably of 200 to less than 800 nm and more preferably of 350 to 790 nm.

5. The method in accordance with claim 1, wherein at least one of the printing ink layers comprising the at least one pigment and/or at least one dye changing its color upon exposition to laser radiation is on one of the two surfaces of the substrate sheet the uppermost printing ink layer.

6. The method in accordance with claim 1, wherein the printing ink of the at least one of the printing ink layers comprising at least one pigment and/or at least one dye changing its color upon exposition to laser radiation is transparent or colorless.

7. The method in accordance with claim 1, wherein the printing ink of at least one of the printing ink layers comprises two or more of pigment(s) and/or dye(s), wherein each of the two or more of pigment(s) and/or dye(s) forms a different color upon exposition to laser radiation with a given intensity and wavelength.

8. The method in accordance with claim 1, wherein the color of the at least one pigment and/or at least one dye changing its color upon exposition to laser radiation contained in the printing ink of at least one of the printing ink layers, which the at least one pigment and/or at least one dye has after termination of the exposition to laser radiation, depends on the wavelength and/or the intensity of the laser so that the at least one pigment and/or at least one dye may change its color upon exposition to laser radiation to one of a plurality of colors.

9. The method in accordance with claim 1, wherein at least one of the printing ink layers comprising the at least one pigment and/or at least one dye changing its color upon exposition to laser radiation further comprises at least one sensitizer, wherein the sensitizer is an infrared absorbing dye, which is preferably selected from the group consisting of polymethyl indoliums, metal complex infrared dyes, indocyanine green, polymethine dyes, croconium dyes, cyanine dyes, merocyanine dyes, squarylium dyes, chalcogeno-pyryloarylidene dyes, metal thiolate complex dyes, quinoline dyes, indolenine dyes, bis(chalcogenopyrylo)-polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, (metalized) azomethine dyes and arbitrary combinations of two or more of the aforementioned compounds.

10. The method in accordance with claim 1, wherein the at least one pigment and/or at least one dye changing its color upon exposition to laser radiation as well as the at least one sensitizer are encapsulated in a capsule made of a polymeric shell, wherein the polymeric shell is preferably made of a polymer being selected from the group consisting of polyamides, polyurea, polyurethanes, polysulfonamides, polyesters, polycarbonates and arbitrary combinations of two or more of the aforementioned polymers.

11. The method in accordance with claim 1, wherein at least one of the printing ink layers comprising the at least one pigment and/or at least one dye changing its color upon exposition to laser radiation further comprises at least one developer compound and/or at least one thermal acid generating compound, wherein the least one developer compound is a phenolic compound, an organic acidic compound, an inorganic acidic compound or an ester or salt thereof, and wherein the least one thermal acid generating compound is a sulfonate ester, a phosphonate ester, an iodonium salt, a sulfonium salt, a ferrocenium salt, a sulfonyl oxime, a halomethyl triazine, a halomethyl-arylsulfone, a haloacetophenone, a sulfonate ester, a t-butyl ester, an allyl substituted phenol, a t-butyl carbonate or a phosphate ester.

12. The method in accordance with claim 1, wherein the at least one pigment and/or at least one dye changing its color upon exposition to laser radiation is selected from the group consisting of spirobenzopyrans, spironaphtooxazines, spirothiopyrans, quinone dyes, oxazines, diazines, thiazines, phenazine, triarylmethane phtalides, diarylmethane phthalides, monoarylmethane phthalides, heterocyclic substituted phthalides, alkenyl substituted phthalides, bridged phthalides, bisphthalides, fluoresceins, rhodamines, rhodols, crystal violet, ketazines and arbitrary combinations of two or more of the aforementioned compounds.

13. The method in accordance with claim 1, wherein at least one of and preferably all of the printing inks of the printing ink layers contain at least one solvent, which is preferably one or more vegetable oils.

14. The method in accordance with claim 1, wherein at least one of and preferably each of the printing inks of the printing ink layers comprises:
i) 0.01 to 50% by weight and preferably 10 to 30% by weight in sum all pigments and dyes,
ii) 10 to 40% by weight and preferably 20 to 30% by weight of one or more binders,
iii) 20 to 60% by weight and preferably 30 to 40% by weight of one or more solvents and
iv) optionally 0.1 to 10% by weight of one or more additives being selected from the selected from the group consisting of rheological additives, adhesives, defoamers, slip additives, anti-corrosion additives, gloss additives, waxes, wetting agents, curing agents, chelating agents, photoinitiators, inhibitors, desiccants, stabilizers, emulsifiers, pH adjustment additives, abrasion resistance additives, plasticizers, antistatic additives, preservatives, light protection agents, matting agents and arbitrary combinations of two or more of the aforementioned additives,
wherein at least one of and preferably all of the printing inks of the printing ink layers contain at least one binder, which is preferably selected from the group consisting of polyesters, polyethers, polyurethanes, polyamides, polyacrylates, maleinate resins, collophonium resins, ketone resins, alkyd resins, collophonium modified phenolic resins, hydrocarbon resins, silicates, silicones, silanes, phenolic resins, urea resins, melamine resins, polyterpene resins, polyvinylalcohols, polyvinylacetates, polyvinylchloride, polyvinylethers, polyvinylpropionates, polymethacrylates, polystyrenes, polyolefines, coumarone-indene resins, aromatic formaldehyde resins, carbamide acid resins, sulfonamide resins, chlorinated resins, nitrocellulose, CAB (cellulose acetate butyrate), CAP (cellulose acetate propionate), cellulose compounds, rubbers, radiation curing resins and arbitrary combinations of two or more of the aforementioned binder.

15. The method in accordance with claim 1, wherein in step iv) one laser beam or more laser beams having different wavelengths are moved relatively to the moving or non-moving substrate sheet so that on the printed and cured substrate sheet one or more serial numbers and optionally one or more QR codes and/or one or more barcodes and optionally further one or more individual security features are generated.

16. The method in accordance with claim 1, wherein in step iv) one or more pulsed laser beams are used, each of which preferably having a pulse duration of 1 fs to 1 ns and preferably of 100 fs to 1 ps and/or each of which having a wavelength of 200 nm to 2,000 nm, preferably of 250 to 1,100 nm, more preferably of 200 to less than 800 nm and yet more preferably of 350 to 790 nm and/or each of which having an energy intensity of 10 mW to 1 kW and preferably of 100 mW to 100 W.

17. The method in accordance with claim 1, wherein in step iv) on every banknote printed on the substrate sheet each one or more serial numbers and optionally one or more QR codes and/or one or more barcodes and optionally further individual security features are generated.

18. A banknote obtainable with a method in accordance with claim 1.
